(19) United States
(12) Patent Application Publication
(10) Pub. No.: US 2025/0165422 A1
(43) Pub. Date: May 22, 2025

(54) DATA PROCESSING SYSTEM AND METHOD, AND STORAGE MEDIUM

(71) Applicant: Hangzhou AliCloud Apsara Information Technology Co., Ltd., Hangzhou (CN)

(72) Inventor: Yuewu LI, Beijing (CN)

(21) Appl. No.: 18/832,468

(22) PCT Filed: Jan. 28, 2023
(86) PCT No.: PCT/CN2023/073592

§ 371 Date: Jul. 23, 2024

(30) Foreign Application Priority Data
Jan. 24, 2022 (CN) 202210076690.3

(51) Int. Cl. G06F 13/40; G06F 13/42; G06F 21/57

(52) U.S. Cl. CPC G06F 13/4022; G06F 13/4282; G06F 21/57; G06F 2213/0026

(57) ABSTRACT

A system includes a server and an intelligence board. The server is connected to the intelligence board through a PCIE physical connection, a SPI bus is built in the server, the intelligence board is configured to switch a PCIE interface module of the intelligence board to an SPI trusted measurement interface module of the intelligence board under a power-on and trustable circumstance, and the SPI trusted measurement interface module is configured to request for target data to be measured from the server through the PCIE physical connection; the intelligence board is configured to acquire the target data that is sent by the server through the SPI and transmitted through the PCIE physical connection, and perform trusted measurement on the target data to obtain a measurement result; the server is configured to switch the SPI to the PCIE for data transmission when the measurement result indicates that the server is trusted.

### CROSS-REFERENCE TO RELATED APPLICATIONS

This application is a National Stage of International Application No. PCT/CN2023/073592, and filed on Jan. 28, 2023, which claims priority to Chinese Patent Application No. 202210076690.3, filed to the China National Intellectual Property Administration on Jan. 24, 2022 and entitled “DATA PROCESSING SYSTEM AND METHOD, AND STORAGE MEDIUM”. The disclosures of the aforementioned applications are hereby incorporated by reference in their entireties.

### TECHNICAL FIELD

The present disclosure relates to the field of computers and, in particular, to a data processing system and method, and a storage medium.

### BACKGROUND

In the related art, since a trusted platform control module (TPCM) in an intelligence board cannot fulfill storage of a boot program (Boot Rom) and measurement of a baseboard management controller (BMC Flash) in a server before the server is started, a serial peripheral interface (SPI) control cable is additionally introduced. However, an additional serial peripheral interface link will increase the usage of input/output on the intelligence board with escalated resource consumption, and a problem of existing of signal quality, thereby resulting in a technical problem of low efficiency of trusted measurement on the server.

In view of the above-mentioned problem, no effective solution has been proposed.

### SUMMARY

Embodiments of the present disclosure provide a data processing system and method, and a storage medium to at least address a technical problem that trusted measurement on a server is low in efficiency.

According to one aspect of an embodiment of the present disclosure, a data processing system is provided. The system may include: a server and an intelligence board, where the server is connected to the intelligence board through a peripheral component interface express (PCIE) physical connection, and a serial peripheral interface (SPI) bus is built in the server, where the intelligence board is configured to switch a PCIE interface module of the intelligence board to an SPI trusted measurement interface module of the intelligence board under a power-on and trustable circumstance, and the SPI trusted measurement interface module is configured to request for target data to be measured from the server through the PCIE physical connection; where the intelligence board is configured to acquire the target data that is sent by the server through the SPI and transmitted through the PCIE physical connection, and perform trusted measurement on the target data to obtain a measurement result; where the server is configured to switch the SPI to the PCIE when the measurement result indicates that the server is trusted, and perform data transmission through the PCIE.

According to another aspect of an embodiment of the present disclosure, a data processing method is further provided. The method may include: in response to an intelligence board being powered on and trusted, switching a PCIE interface module of the intelligence board to an SPI trusted measurement interface module of the intelligence board, where the SPI trusted measurement interface module is configured to request for target data to be measured from a server through a PCIE physical connection; acquiring the target data that is sent by the server through a built-in serial peripheral interface (SPI) bus and transmitted through the PCIE physical connection; performing trusted measurement on the target data to obtain a measurement result, where when the measurement result indicates that the server is trusted, the SPI is switched to the PCIE by the server, and the server performs data transmission through the PCIE.

According to yet another aspect of an embodiment of the present disclosure, a data processing apparatus is further provided. The apparatus may include: a first switching unit, configured to, in response to an intelligence board being powered on and trusted, switch a PCIE interface module of the intelligence board to an SPI trusted measurement interface module of the intelligence board, where the SPI trusted measurement interface module is configured to request for target data to be measured from a server through a PCIE physical connection; a first acquiring unit, configured to acquire the target data that is sent by the server through a built-in serial peripheral interface (SPI) bus and transmitted through the PCIE physical connection; a second switching unit, configured to perform trusted measurement on the target data to obtain a measurement result, where when the measurement result indicates that the server is trusted, the SPI is switched to the PCIE by the server, and the server performs data transmission through the PCIE.

According to yet another aspect of an embodiment of the present disclosure, a computer-readable storage medium is further provided. The computer-readable storage medium includes a program stored thereon, where when the program, when running, controls a device in which the storage medium is located to execute the data processing method according to any item described above.

According to yet another aspect of an embodiment of the present disclosure, a processor is further provided. The processor is configured to run a program, where the data processing method according to any item described above is performed when the program is running.

In the embodiments of the present disclosure, the data processing system may include the server and the intelligence board. The server is connected to the intelligence board through the peripheral component interface express (PCIE) physical connection, and the serial peripheral interface (SPI) bus is built in the server, where the server is configured to switch the PCIE interface module of the intelligence board to an SPI trusted measurement interface module of the intelligence board under the power-on and trustable circumstance, and the SPI trusted measurement interface module is configured to request for target data to be measured from the server through the PCIE physical connection; where the intelligence board is configured to acquire the target data that is sent by the server through the SPI and transmitted through the PCIE physical connection, and perform trusted measurement on the target data to obtain the measurement result; where the server is configured to switch the SPI to the PCIE when the measurement result indicates that the server is trusted, and perform data transmission through the PCIE. That is to say, in the present disclosure, the trusted measurement prior to the startup of the server would be accomplished by means of time division multiplexing for the PCIE physical connection of the server, without extra addition of the serial peripheral interface cable, thereby achieving the technical effect of improving the efficiency of trusted measurement on the server, and solving the technical problem of low efficiency of the trusted measurement on the server.

### BRIEF DESCRIPTION OF DRAWINGS

Drawings illustrated here are provided for further understanding the present disclosure and constituting part of the present application. Schematic embodiments of the present disclosure and explanations thereof are used to explain the present disclosure, rather than constituting an improper limitation to the present disclosure.

FIG. 1 is a schematic diagram of a data processing system according to an embodiment of the present disclosure.

FIG. 2 is a block diagram of a hardware structure of a computer terminal (or a mobile device) for a data processing method according to an embodiment of the present disclosure.

FIG. 3 is a flowchart of a data processing method according to an embodiment of the present disclosure.

FIG. 4 is a schematic diagram of a server having two trusted platform control modules (i.e., trusted modules) according to the related art of the present disclosure.

FIG. 5 is a schematic block diagram of a trusted system of a peripheral component interface express based trusted platform control module according to an embodiment of the present disclosure.

FIG. 6 is a schematic diagram of a power-on sequence of a whole machine according to an embodiment of the present disclosure.

FIG. 7 is a schematic diagram of a trusted chain transfer according to an embodiment of the present disclosure.

FIG. 8 is a schematic diagram of a data processing apparatus according to an embodiment of the present disclosure.

FIG. 9 is a structural block diagram of a computer terminal according to an embodiment of the present disclosure.

### DESCRIPTION OF EMBODIMENTS

In order to enable those skilled in the art to better understand solutions of the present disclosure, technical solutions in embodiments of the present disclosure will be described hereunder clearly and comprehensively in combination with drawings in the embodiments of the present disclosure. Apparently, the described embodiments are part of the embodiments of the present disclosure, rather than all of them. Based on the embodiments in the present disclosure, all other embodiments obtained by those of ordinary skill in the art without any creative effort should belong to the protection scope of the present disclosure.

It should be noted that, terms “first”, “second”, etc. in the description, claims, and the above-mentioned drawings of the present disclosure are used to distinguish similar objects, but not necessarily to describe a specific order or sequence. It should be understood that, the data used in this way is interchangeable where appropriate, so that the embodiments of the present disclosure described herein can be implemented in an order other than those illustrated or described herein. In addition, terms “include” and “have” and any variations of them are intended to cover non-exclusive inclusion. For example, processes, methods, systems, products or devices containing a series of steps or units are not necessarily limited to those steps or units that are clearly listed, but can include other steps or units that are not clearly listed or are inherent to these processes, methods, products or devices.

Firstly, some terms or terminologies used in describing the embodiments of the present application are applicable to the following interpretations:
a trusted platform module (TPM), configured to process encryption keys in a device by using a dedicated microcontroller integrated in a device;
a trusted platform control module (TPCM), configured to establish and secure trusted sources and provide trusted platform control;
a basic input output system (input output system), being an industry-standard firmware interface;
a baseboard management controller (BMC), configured to conduct firmware upgrade of a machine when the machine has not started, check a machine device or perform other operations;
a peripheral component interface express (PCIE), configured for point-to-point dual-channel high-bandwidth transmission.

The trusted platform control module (TPCM) is integrated in a trusted computing platform, and its key role is to measure a small piece of mask Rom embedded inside a processor chip or store a boot program (Boot Rom) as well as a BMC Boot Rom and other devices, to avoid system tampering and guarantee a secure and trusted server.

### Embodiment 1

An embodiment of the present disclosure may provide a data processing system that may include a computer terminal, where the computer terminal may be any computer terminal device in a cluster of computer terminals. In the present embodiment, the aforementioned computer terminal may also be replaced with a terminal device such as a mobile terminal.

In the present embodiment, the aforementioned computer terminal may be located in at least one of a plurality of network devices of a computer network.

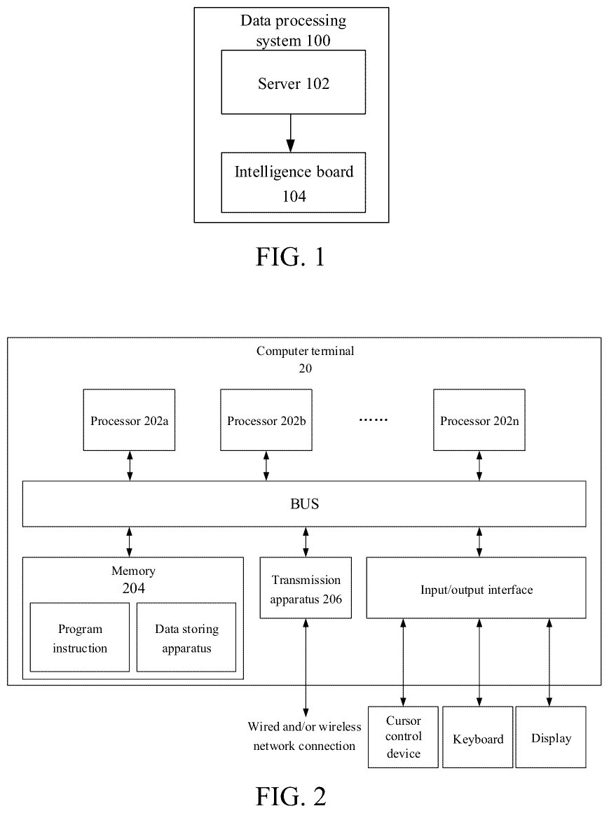

FIG. 1 is a flowchart of a data processing system according to an embodiment of the present disclosure. As shown in FIG. 1, the data processing system 100 may include: a server 102 and an intelligence board 104, where the server 102 is connected to the intelligence board 104 through a peripheral component interface express (PCIE) physical connection, and a serial peripheral interface (SPI) bus is built in the server 102.

The server 102 is configured to control power-on of the intelligence board 104 through a sequential control circuit.

In this embodiment, the sequential control circuit in the server 102 controls power-on of the intelligence board 104, where the server 102 may include parts such as an SPI on-off switching module, a PCIE on-off switching module and a sequential control module; and the sequential control circuit may be included in the sequential control module, and can be configured to control the power-on or de-resetting timing sequence of the intelligence board 104 and the server 102.

In an implementation, when the entire device is powered on, the sequential control circuit of the server 102 controls the power-on of the intelligence board 104 through the sequential control module.

The intelligence board 104 is configured to switch a PCIE interface module of the intelligence board 104 to an SPI trusted measurement interface module of the intelligence board 104 under a power-on and trustable circumstance, and the SPI trusted measurement interface module is configured to request for target data to be measured by the server 102 through the PCIE physical connection; where the intelligence board 104 is configured to acquire the target data that is sent by the server 102 through the SPI and transmitted through the PCIE physical connection, and perform trusted measurement on the target data to obtain a measurement result; where the server 102 is configured to switch the SPI to the PCIE when the measurement result indicates that the server 102 is trusted, and perform data transmission through the PCIE.

In this embodiment, a power-on signal of the entire device is acquired; based on the acquired power-on signal, the sequential control circuit of the server 102 controls the power-on of the intelligence board 104 through the sequential control module; under a power-on and trustable circumstance, a PCIE interface module of the intelligence board 104 is switched to an SPI trusted measurement interface module of the intelligence board 104; and target data to be measured is requested from the server 102 through the PCIE physical connection; the target data to be measured is acquired from the server 102, and trusted measurement is performed on the acquired target data to obtain a measurement result; where the server 102 can be configured to switch the SPI to the PCIE when the measurement result indicates that the server 102 is trusted, and perform data transmission through the PCIE physical connection; where the target data may be BM Flash and Boot Rom; the measurement result may be a notification that the intelligence board 104 completes the measurement, either a trusted or untrusted measurement result; and the PCIE may be known as a high speed serial bus.

In an implementation, when the intelligence board 104 completes the measurement of the target data for the server 102, a trusted signal is issued; in response to the trusted signal issued by the intelligence board 104, the PCIE is switched to the serial peripheral interface (SPI) bus; and the target data of the server 102 is sent to the intelligence board 104 through the PCIE physical connection; and the intelligence board 104 measures the target data to obtain the measurement result that the server 102 is trusted.

In the embodiment of the present disclosure, the server 102 and the intelligence board 104 are provided. The server 102 is connected to the intelligence board 104 through the peripheral component interface express (PCIE) physical connection, and a serial peripheral interface (SPI) bus is built in the server 102, where the server 102 is configured to control power-on of the intelligence board 104 through a sequential control circuit; the intelligence board 104 is configured to switch the PCIE interface module of the intelligence board 104 to the SPI trusted measurement interface module of the intelligence board 104 under the power-on and trustable circumstance, and the SPI trusted measurement interface module is configured to request for the target data to be measured by the server 102 through the PCIE physical connection; where the intelligence board 104 is configured to acquire the target data that is sent by the server 102 through the SPI and transmitted through the PCIE physical connection, and perform trusted measurement on the target data to obtain the measurement result; the server 102 is configured to switch the SPI to the PCIE when the measurement result indicates that the server 102 is trusted, and perform data transmission through the PCIE. That is to say, in the present disclosure, the trusted measurement prior to the startup of the server 102 would be accomplished by means of time division multiplexing for the server 102 through the PCIE physical connection, without extra addition of a serial peripheral interface cable, thereby achieving the technical effect of improving the efficiency of trusted measurement on the server, and solving the technical problem of low efficiency of the trusted measurement on the server.

The aforementioned method of this embodiment will be further described hereunder.

As a system, the server includes: an SPI on-off switching module, configured to switch the SPI to the PCIE physical connection.

In this embodiment, a sequential control module of the server receives the measurement result from the intelligence board and switches, through the SPI on-off switching module, the SPI bus to the PCIE physical connection, to switch from the intelligence board to a baseboard management controller (BMC) and a central processing unit (CPU) of the server.

In an implementation, after the device is powered on, the server may control the SPI on-off switching module to switch the SPI to the PCIE physical connection, at this point, the intelligence board may get access to target data of the server, and the intelligence board reads the target data of the server.

As a system, the server includes: a sequential control module, configured to control the SPI on-off switching module to switch the SPI to a baseboard management controller (BMC) and a central processing unit (CPU) of the server, after the measurement result is obtained by the intelligence board through performing the trusted measurement on the target data.

In this embodiment, the sequential control module is configured to control the SPI on-off switching module to switch the SPI from the intelligence board to the baseboard management controller (BMC) and the central processing unit (CPU), after the intelligence board performs the trusted measurement on the target data and the sequential control module receives the measurement result from the intelligence board.

In an implementation, the sequential control circuit of the server controls power-on of the intelligence board through the sequential control module, the intelligence board begins to perform trusted measurement on the target data after completing its own trusted measurement, and after completing the trusted measurement on the target data, the intelligence board controls the SPI on-off switching module to switch from the SPI trusted measurement interface module to the PCIE interface module, and controls the baseboard management controller (BMC) and the central processing unit (CPU), to achieve the purpose of switching the SPI from the intelligence board to the baseboard management controller (BMC) and the central processing unit (CPU).

In an implementation, the SPI can be switched from the intelligence board to the baseboard management controller (BMC) and the central processing unit (CPU) of the server through the SPI on-off switching module.

As a system, the SPI on-off switching module is configured to control, based on the SPI, the BMC to access data in a first memory BMC Flash of the server, and control, based on the SPI, the CPU to access data in a second memory Boot Rom of the server.

In this embodiment, the SPI on-off switching module is configured to control access permission to the Boot Rom by the CPU of the server or the intelligence board, and control access permission to the BMC Flash by the BMC of the server or the intelligence board.

In an implementation, after the device is powered on, a trusted measurement apparatus B switches the SPI switching (bus) to the intelligence board; at this point, the intelligence board can access the Boot Rom and the BMC Flash of the server, and the intelligence board reads the data in the Boot Rom and the BMC Flash of the server to complete the measurement.

As a system, the BMC is configured to start based on the data in the first memory BMC Flash of the server, the started BMC Flash is configured to control the CPU to start based on the data in the second memory Boot Rom of the server, and the started CPU is configured to control an operating system of the server to start, to control the PCIE for data transmission.

In this embodiment, the baseboard management controller (BMC) and the central processing unit (CPU) are powered on or de-reset, so that the baseboard management controller (BMC) and the central processing unit (CPU) subjected to the power-on or de-resetting read the target data in the memories to complete the startup, the baseboard management controller (BMC) and the central processing unit (CPU) load input and output system programs for initializing the system hardware and leading the system of the server to start at the same time, where the startup of the system of the server can be the startup of the operation system (OS) of the server; and the started CPU controls the operation system of the server to start, to control the PCIE for data transmission.

In an implementation, the baseboard management controller (BMC) and the central processing unit (CPU) are powered on or de-reset, data in the first memory BMC Flash of the baseboard management controller is read to render completion of the startup, the started BMC Flash is configured to control the power-on or the de-resetting of the CPU, the CPU reads the data in the second memory Boot Rom of the server to complete the startup, and the started CPU controls the operating system of the server to start, so as to achieve the purpose of controlling the PCIE for data transmission.

In an implementation, the Boot Rom stores an input/output program (BIOS program) or an input/output system program (UEFI BIOS program) of an unified extensible firmware interface (UEFI); when being started, the central processing unit firstly loads from the BMC Flash the input/output system program to initialize the system hardware, and then lead the system of the server to start, thereby achieving the purpose of enabling the system of the server to start and run in a trusted environment.

As a system, the target data includes the data in the BMC Flash and the data in the Boot Rom.

In this embodiment, the intelligence board measures the target data, that is, the intelligence board measures the data in the Boot Rom and the BMC Flash of the server.

In an implementation, the BMC program is stored in the BMC Flash to ensure that the operating system of the CPU of the intelligence board is trusted; and the BIOS program or the UEFI BIOS program is stored in the Boot Rom, which is configured to initialize the system hardware and lead the operating system to start.

As a system, the server includes a PCIE on-off switching module configured to switch the SPI to the PCIE.

In this embodiment, the PCIE on-off switching module is configured to switch the PCIE slot physical connection to the SPI and the sequential control module, or to switch the SPI to the PCIE bus of the CPU, thereby achieving time division multiplexing of the PCIE slot physical lines.

In an implementation, the PCIE bus is switched from the intelligence board to the baseboard management controller and the central processing unit of the server by the PCIE on-off switching module; and a switch from the SPI to the PCIE is made by the PCIE on-off switching module leveraging PCIE physical connection.

As a system, the intelligence board includes an interface switching module configured to switch the PCIE interface module to the SPI trusted measurement interface module.

In this embodiment, the intelligence board includes an interface switching module, and the interface switching module is used to achieve the purpose of switching the PCIE interface module to the SPI trusted measurement interface module.

In this embodiment, the intelligence board includes an SPI trusted measurement interface module, where the SPI trusted measurement interface module is configured to enable the SPI bus function, and devices such as the Boot Rom and the BMC Flash of the server are accessed through the SPI to achieve the purpose of fetching the target data.

In an implementation, when completing the measurement on the target data of the server, the intelligence board issues a trusted signal; and in response to the trusted signal issued by the intelligence board, the target data of the server is sent to the intelligence board through the serial peripheral interface bus.

As a system, the interface switching module is further configured to switch the SPI trusted measurement interface module to the PCIE interface module after the measurement result is obtained by performing the trusted measurement on the target data.

In this embodiment, the intelligence board includes: an interface switching module, configured to switch the SPI trusted measurement interface module to the PCIE interface module of the intelligence board after the measurement result is obtained by performing the trusted measurement on the target data, where the PCIE interface module is used in such a way that the intelligence board enters the PCIE interface mode.

In an implementation, the interface switching module is configured to make a switch between the SPI trusted measurement interface module and the PCIE interface module, the device, after being powered on, operates in a SPI trusted measurement interface mode for measurement, and after the measurement is completed, the interface switching module switches the SPI trusted measurement interface module to the PCIE interface module of the intelligence board.

As a system, the intelligence board includes a trusted platform control module (TPCM) configured to perform trusted measurement on an operating system of the intelligence board, where a trusted operating system is configured to perform the trusted measurement on the target data to obtain the measurement result.

In this embodiment, the intelligence board includes a trusted platform control module (TPCM), and a trusted operating system is used to perform the trusted measurement on the target data to obtain the measurement result.

In an implementation, the TPCM module is configured to measure the Boot Rom and the BMC Flash of the intelligence board. The Boot Rom ensures that the OS run by the CPU of the intelligence board is trusted. After the OS is started by the CPU of the intelligence board, a swtpm (software TPM) program is run to complete the measurement of the server.

In the embodiments of the present disclosure, the data processing system may include the server and the intelligence board. The server is connected to the intelligence board through the peripheral component interface express (PCIE) physical connection, and the serial peripheral interface (SPI) bus is built in the server, where the server is configured to switch the PCIE interface module of the intelligence board to an SPI trusted measurement interface module of the intelligence board under the power-on and trustable circumstance, and the SPI trusted measurement interface module is configured to request for target data to be measured from the server through the PCIE physical connection; where the intelligence board is configured to acquire the target data that is sent by the server through the SPI and transmitted through the PCIE physical connection, and perform trusted measurement on the target data to obtain the measurement result; where the server is configured to switch the SPI to the PCIE when the measurement result indicates that the server is trusted, and perform data transmission through the PCIE. That is to say, in the present disclosure, the trusted measurement prior to the startup of the server would be accomplished by means of time division multiplexing for the PCIE physical connection of the server, without extra addition of the serial peripheral interface cable, thereby achieving the technical effect of improving the efficiency of trusted measurement on the server, and solving the technical problem of low efficiency of the trusted measurement on the server.

### Embodiment 2

According to an embodiment of the present disclosure, an embodiment of a data processing method is further provided. It should be noted that steps shown in the flowcharts of the drawings can be performed in a computer system such as a set of computer-executable instructions, and although the logical sequence is shown in the flowcharts, the steps shown or described can be executed in a different order from herein in some situations.

The method embodiment according to Embodiment 1 of the present application may be executed in a mobile terminal, a computer terminal or a similar computing apparatus. FIG. 2 illustrates a block diagram of a hardware structure of a computer terminal (or a mobile device) for implementing a data processing method. As shown in FIG. 2, a computer terminal 20 (or a mobile device 20) may include one or more (shown by using 202a, 202b, . . . and 202n in the figure) processors 202 (the processor 202 may include, but is not limited to, a microprocessor (MPU) or a programmable logical device FPGA or other processing apparatuses), a memory 204 for storing data, and a transmission apparatus 206 for communication functions. Besides, the following are further included: a display, an input/output interface (I/O interface), a universal serial bus (USB) port (which can be included as one of the ports for the I/O interface), a network interface, a power supply and/or a camera. Persons of ordinary skill in the art may understand that the structure shown in FIG. 2 is merely illustrative and does not limit the structure of the aforementioned electronic apparatus. For example, the computer terminal 20 may also include more or fewer components than those shown in FIG. 2 or have a different configuration from that shown in FIG. 2.

It should be noted that the one or more processors 202 and/or other data processing circuits as mentioned above may be generally termed herein as the “data processing circuit(s)”. The data processing circuit(s) can be embodied in whole or in part as software, hardware, firmware or any other combinations. In addition, the data processing circuits may be separate standalone processing modules, or may be combined in whole or in part into any one of other elements in the computer terminal 20 (or a mobile device). As involved in the embodiment of the present application, the data processing circuit is used as a processor for controlling, for example, path selection for a variable resistor terminal connected to an interface.

The memory 204 can be configured to store a software program and a module of application software, such as a program instruction/a data storage apparatus corresponding to the data processing method in the embodiment of the present disclosure, and the processor 202 performs various functional applications and data processing by running the software program and the module stored in the memory 204, that is, implementing the aforementioned data processing method for the application program. The memory 204 may include a high-speed random access memory or a non-volatile memory, such as one or more magnetic memory apparatuses, flash memories or other non-volatile solid-state memories. In some instances, the memory 204 may further include memories remotely arranged with respect to the processor 202, and these remote memories can be connected to the computer terminal 20 via a network. Instances of the above-described network include, but are not limited to, Internet, an intranet, a local area network, a mobile communication network and a combination thereof.

The transmission apparatus 206 is configured to receive or send data via a network. Specific instances of the aforementioned network may include a wireless network provided by a communications provider for the computer terminal 20. In one instance, the transmission apparatus 206 includes a network adapter (Network Interface Controller, NIC) connectable to other network equipment through a base station for communications with the Internet. In one instance, the transmission apparatus 206 may be a radio frequency (RF) module configured to communicate with the Internet in a wireless manner.

The display may be, for example, a touchscreen-type liquid crystal display (LCD), and the liquid crystal display enables a user interaction with a user interface of the computer terminal 20 (or the mobile device).

To be noted here, in some embodiments, the computer device (or the mobile device) shown in FIG. 2 may include a hardware element (including circuits), a software element (including computer codes stored in a computer-readable medium) or a combination of the hardware element and the software element. It should be noted that FIG. 2 is only an example of a particular specific instance and is intended to illustrate types of parts that may exist in the foregoing computer device (or the mobile device).

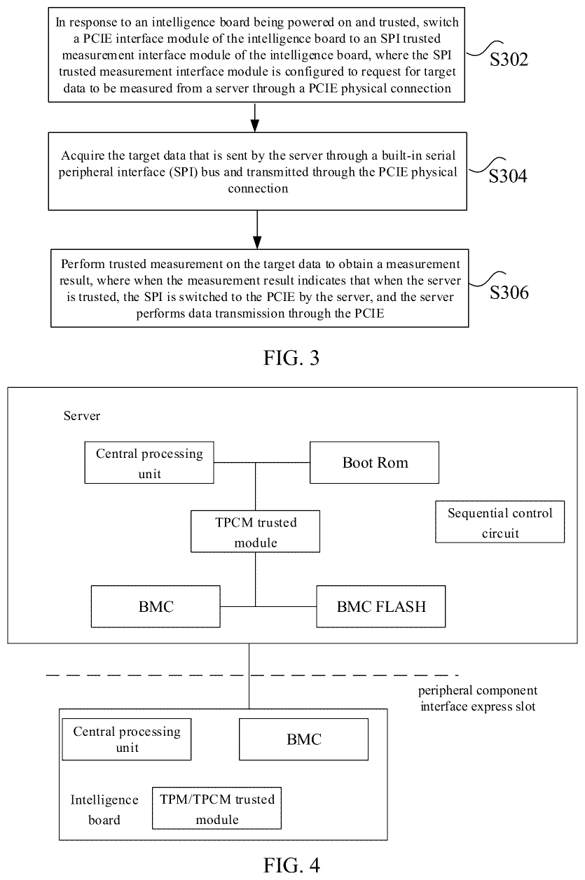

In the operating environment shown in FIG. 2, the present application provides a data processing method as shown in FIG. 3. It should be noted that the data processing method in this embodiment may be performed by the mobile terminal according to the embodiment shown in FIG. 2.

FIG. 3 is a flowchart of a data processing method according to an embodiment of the present disclosure. As shown in FIG. 3, the method may include the following steps.

Step S302: in response to an intelligence board being powered on and trusted, switch a PCIE interface module of the intelligence board to an SPI trusted measurement interface module of the intelligence board, where the SPI trusted measurement interface module is configured to request for target data to be measured from a server through a PCIE physical connection.

In the technical scheme provided in the foregoing step S302 of the present disclosure, a power-on signal of a device is acquired; based on the acquired power-on signal, a peripheral component interface express (PCIE) is switched to a serial peripheral interface (SPI) bus, to allow for a switch to the intelligence board by the server, so that the server is connected with the intelligence board; the intelligence board is measured, and a trusted measurement result is issued; and in response to the trusted measurement result of the intelligence board the target data to be measured by the server is sent to the intelligence board through the serial peripheral interface (SPI) bus.

In an implementation, when the intelligence board completes the measurement of the storage of the boot program and the data in the flash of the baseboard management controller of the server, a trusted signal is issued, and in response to the trusted signal issued by the intelligence board, the target data to be measured by the server is sent to the intelligence board through the serial peripheral interface bus.

Step S304: acquire the target data that is sent by the server through a built-in serial peripheral interface (SPI) bus and transmitted through the PCIE physical connection.

In the technical scheme provided in the foregoing step S304 of the present disclosure, the serial peripheral interface (SPI) bus is controlled based on the power-on signal, so that the PCIE interface module of the intelligence board is switched to the SPI trusted measurement interface module of the intelligence board, and the target data is transmitted through the PCIE physical connection.

In an implementation, after the device is powered on, the serial peripheral interface (SPI) bus is controlled based on the power-on signal, and the PCIE interface module of the intelligence board is switched to the SPI trusted measurement interface module of the intelligence board, and at this point, the target data is transmitted through the PCIE physical connection to achieve a purpose of sending the target data from the memory of the server to the target board.

Step S306: perform trusted measurement on the target data to obtain a measurement result, where when the measurement result indicates that when the server is trusted, the SPI is switched to the PCIE by the server, and the server performs data transmission through the PCIE.

In the technical scheme provided in the foregoing step S306 of the present disclosure, the trusted measurement is performed on the target data to obtain a measurement result, and when the measurement result indicates that the server is trusted, the SPI is switched to the PCIE by the server, and the server performs data transmission through the PCIE.

In the embodiment of the present disclosure, in response to an intelligence board being powered on and trusted, a peripheral component interface express (PCIE) between the sever and the intelligence board is switched to a serial peripheral interface (SPI) bus, and target data to be measured by the server is acquired through the SPI, and trusted measurement is performed on the target data to obtain a measurement result; and in response to the measurement result indicating that the server is trusted, the SPI is switched to the PCIE, and data transmission is performed through the PCIE. That is to say, in the present disclosure, the trusted measurement prior to the startup of the server would be accomplished by means of time division multiplexing for the PCIE physical connection of the server, without extra addition of the serial peripheral interface cable, thereby achieving the technical effect of improving the efficiency of trusted measurement on the server, and solving the technical problem of low efficiency of the trusted measurement on the server.

### Embodiment 3

Further introduction will be made hereunder to a preferred implementation of the aforementioned method in the embodiment, and detailed description is made to a trusted check based on a peripheral component interface express.

Currently, the trusted measurement on the server is based on the following three methods: the first is an external serial peripheral interface (serial peripheral interface) bus, this method imposes a great challenge to signal quality and is unstable though with reduced costs for chips of the trusted platform control module and accomplishment of transfer for a single trusted chain; the second is a scheme of an external serial peripheral interface cable, however, this method greatly limits system scalability; and the third is an external serial peripheral interface bus, however, this method increases resource consumption of an IO interface.

In order to solve the aforementioned problem, a related technology can be that TPCM trusted modules on both the intelligence board and the server are regarded as trusted modules measuring their respective systems. FIG. 4 is a schematic diagram of a server having two trusted platform control modules, i.e., trusted modules, according to the related art of the present disclosure. As shown in FIG. 4, the server includes parts such as a central processing unit, a baseboard management controller, a Boot Rom, a BMC Flash, a sequential control circuit and a trusted platform control module, where the Boot Rom stores an input/output system program of an input/output system or an input/output system program of a unified extensible firmware interface (UEFI), and the central processing unit, when being started, firstly loads the BIOS program from the Boot Rom to initialize the system hardware, and leads the operating system to start; the BMC Flash stores a BMC program, and the BMC, when being started, firstly loads the BMC program; the trusted platform control module, i.e., trusted module, is started in the first place after the server is powered on. Before startup of the central processing unit and the BMC, data in the Boot Rom and data in the BMC Flash are measured to ensure that the data in the Boot Rom and the data in the BMC Flash are trusted. After that, the trusted platform control module notifies the sequential control circuit to control the central processing unit and the baseboard management controller to power on or de-reset, so that the server can start and run in a trusted environment.

A peripheral component interface express slot exists on the server, and the peripheral component interface express slot can be inserted into the intelligence board; the intelligence board includes thereon parts such as a central processing unit, a baseboard management controller and a trusted platform control module; and the trusted platform control module on the intelligence board has the same trusted measurement process as that of the trusted platform control module on the server.

However, both the server and the intelligence board in the foregoing method have trusted platform control modules, i.e., trusted modules, which increases the material cost and the later operation and maintenance cost. The trust of the server is measured by the trusted platform control module, i.e., trusted module, on the server, they two are strongly bound, and migration cannot be supported in cloud computing usage scenarios. Both the server and the intelligence board have the trusted platform control modules, i.e., trusted modules, so that two trusted chains exist in the whole system, one of which is a trusted chain from the trusted platform control module on the server to the data in the Boot Rom and the data in the BMC Flash to the system, and the other one of which is a trusted chain from the trusted platform control module on the intelligence board to the data in the Boot Rom and the data in the BMC Flash to the system.

In another related technology, the trusted platform control module, i.e., trusted module, on the server is removed, and only the trusted platform control module, i.e., trusted module, on the intelligence board is retained, however, in this method, the intelligence board is connected with the server through a peripheral component interface express, and the trusted platform control module, i.e., trusted module, cannot complete the measurement of the data in the Boot Rom and the data in the BMC Flash of the server before the central processing unit of the server is started, so that a serial peripheral interface cable is additionally introduced, which is a controlling cable for notifying the sequential control circuit of the server to control the central processing unit and the baseboard management controller to power on or de-reset. The serial peripheral interface cable effectuates the access to the data in the Boot Rom and the data in the BMC Flash of the server, so that the data in the Boot Rom and the data in the BMC Flash can be measured, and meanwhile a control signal is contained in the serial peripheral interface cable.

In the foregoing method, the additional serial peripheral interface cable has a problem of signal quality, and the hardware link is unreliable. The additional serial peripheral interface link increases the amount of usage of interfaces on the intelligence board and increases the resource consumption, and the resource consumption of the additional serial peripheral interface in turn may lead to degraded specifications when a single intelligence board is connected to multiple servers; and when a single intelligence board is connected to multiple servers, it is necessary to add multiple additional serial peripheral interface cables, resulting in complicated installation and maintenance.

In order to solve the aforementioned problem, trusted measurement based on a peripheral component interface express is proposed in the embodiment, which allows for trusted measurement on the server by the system without an external serial peripheral interface cable, not only retaining the advantages of the external serial peripheral interface scheme, but also handling the disadvantages thereof.

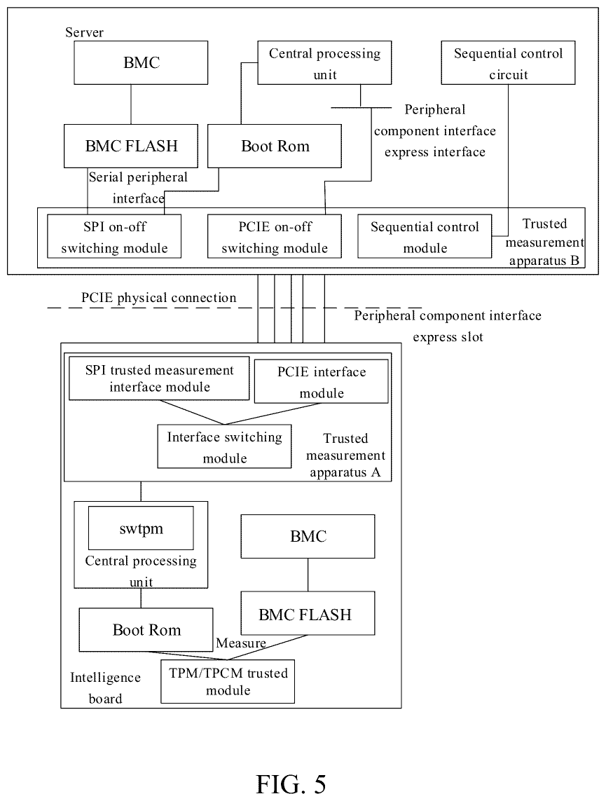

FIG. 5 is a schematic diagram of a data processing method according to an embodiment of the present disclosure. As shown in FIG. 5, the server includes parts such as a central processing unit, a baseboard management controller (BMC), a Boot Rom, a BMC Flash, a sequential control circuit (module), a trusted platform control module, i.e., trusted module, and a trusted measurement apparatus B, where the trusted apparatus B on the server includes parts such as an SPI on-off switching module, a peripheral component interface express on-off switching module and a sequential control module. The intelligence board includes parts such as a central processing unit, a baseboard management controller (BMC), a Boot Rom, a BMC Flash, a trusted platform control module, i.e., trusted module, and a trusted measurement apparatus A, where the trusted apparatus A on the intelligence board includes parts such as a serial peripheral interface trusted measurement interface module, a peripheral component interface express interface module and an interface switching module. The intelligence board is connected to the server via a peripheral component interface express slot.

In an implementation, the Boot Rom on the intelligence board stores an input/output system program of an input/output system or unified extensible interface firmware, and the CPU, when being started, firstly loads the input/output system program from the Boot Rom to initialize the system hardware, and leads the operating system to start; and the BMC Flash stores a BMC program, and the baseboard management controller, when being started, firstly loads the baseboard management controller program.

In an implementation, the trusted platform control module is configured to measure data in the Boot Rom and data in the BMC Flash of the intelligence board, and the Boot Rom ensures that the operating system run by the central processing unit of the intelligence board is trusted. After the central processing unit of the intelligence board starts the operating system, a program of a software trusted platform module (software TPM, abbreviated as swtpm) is run to complete the measurement of the server.

In an implementation, the serial peripheral SPI interface trusted measurement interface module implements a SPI bus function and is configured to access devices such as the Boot Rom and the BMC Flash of the server. The peripheral component interface express (PCIE) interface module is configured to implement peripheral component interface express equipment, and the interface operates in a peripheral component interface express interface mode after the intelligence board completes the measurement on the data in the Boot Rom and the BMC Flash of the server.

In an implementation, the interface switching module is configured to make a switch between the serial peripheral interface trusted measurement interface module and the peripheral component interface express interface module, and after the device is powered on, the trusted measurement apparatus A operates in a serial peripheral interface trusted measurement interface mode, and after the measurement is completed, the central processing unit switches the trusted apparatus A to the peripheral component interface express interface mode through the interface switching module.

In an implementation, the SPI on-off switching module in the trusted apparatus B on the server is configured to control access permission to the Boot Rom by the central processing unit of the server or the intelligence board, and to control access permission to the BMC Flash by the baseboard management controller of the server or the intelligence board. After the device is powered on, the trusted measurement apparatus B switches the SPI on-off switching module to the intelligence board, and at this point, the intelligence board can access the Boot Rom and the BMC Flash of the server, and the intelligence board reads the data in the Boot Rom and the data in the BMC Flash of the server to complete the measurement.

After the intelligence board completes the measurement on the data in the Boot Rom and the data in the BMC Flash of the server, the trusted apparatus B makes a switch from a BMC Flash to the baseboard management controller of the server through the SPI on-off switch module, so that the baseboard management controller of the server can access the BMC Flash at this point, and makes a switch from the Boot Rom to the central processing unit of the server through the SPI on-off switching module, so that the central processing unit of the server can access the Boot Rom. The peripheral component interface express on-off switching module is configured to switch the peripheral component interface express slot physical connection to the serial peripheral interface and the sequential control module, or to the peripheral component interface express of the central processing unit, thereby achieving the time-division multiplexing of the peripheral component interface express slot physical lines.

In an implementation, the sequential control module in the trusted apparatus B on the server is configured to control power-on or sequential de-resetting of the intelligence board and the server; when the device is powered on, the sequential control circuit of the server controls power-on of the intelligence board through the sequential control module; the intelligence board, after completing its own trusted measurement, begins to measure the Boot Rom and the BMC Flash of the server; and after completing the measurement on the data in the Boot Rom and the data in the BMC Flash of the server, the intelligence board switches the interface of the trusted measurement apparatus A from the serial peripheral interface trusted measurement interface module to the peripheral component interface express interface module, and notifies the sequential control module of the trusted measurement apparatus B of the server. After the sequential control module receives the notification that the intelligence board has completed the measurement, the serial peripheral interface bus is switched from the intelligence board to the base board management controller and central processing unit of the server through the SPI on-off switching module; and the physical peripheral component interface express slot physical connection is switched from the serial peripheral interface to the peripheral component interface express through the peripheral component interface express on-off switching module, and after that, the baseboard management controller is powered on or de-reset, the baseboard management controller reads the data in the BMC Flash to complete the startup, and then the central processing unit is powered on or de-reset, the central processing unit reads the data in the Boot Rom to complete the startup, and the input/output system or the UEFI input/output system can normally scan the peripheral component interface express of the intelligence board after the central processing unit is started; after the OS of the server is started, for the trusted measurement, the data transmission is completed through the peripheral component interface express.

It should be noted that the peripheral component interface express of the server cannot be used until an enumeration configuration by the central processing unit, and the enumeration configuration of the peripheral component interface express by the central processing unit depends on the execution of the input/output system program in the Boot Rom, and the execution of the input/output system program in turn depends on the trusted measurement through the trusted platform control module. In order to solve this problem, the PCIE physical connection is multiplexed as a serial peripheral interface bus and a sequential control signal line according to the present disclosure, to ensure that the server is started to scan the peripheral component interface express after the intelligence board completes the measurement for the Boot Rom and the BMC Flash of the server.

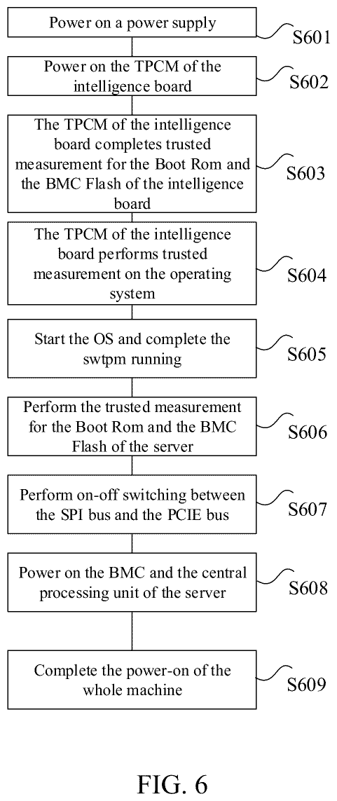

FIG. 6 is a schematic diagram of a power-on sequence of a whole machine according to an embodiment of the present disclosure. As shown in FIG. 6, the power-on sequence of the whole machine according to the present disclosure has the following steps.

Step S601: power on a power supply.

In this embodiment, the power-on may be for the power supply of the whole device.

Step S602: power on the TPCM of the intelligence board.

In this embodiment, the sequential control circuit of the server controls the TPCM of the intelligence board to power on.

Step S603: the TPCM of the intelligence board completes trusted measurement for the Boot Rom and the BMC Flash of the intelligence board.

In this embodiment, the TPCM of the intelligence board completes the trusted measurement for the Boot Rom and the BMC Flash of the intelligence board, and the BMC and the CPU of the intelligence board are powered on.

Step S604: the TPCM of the intelligence board performs trusted measurement on the operating system.

In this embodiment, the TPCM of the intelligence board completes the trusted measurement for the Boot Rom and the BMC Flash of the intelligence board, the BMC and the CPU of the intelligence board are powered on, and the trusted platform control module of the intelligence board completes the trusted measurement of the operating system by the intelligence board.

Step S605: start the OS and complete the swtpm running.

In this embodiment, the operating system is started and the running of the trusted platform module software is completed; the trusted platform control module of the intelligence board completes the trusted measurement of the operating system by the intelligence board, and a trusted measurement result is fed back; and the operating system is started, and the running of the trusted platform module software is completed.

Step S606: perform the trusted measurement for the Boot Rom and the BMC Flash of the server.

In this embodiment, the operating system is started, the running of the trusted platform module software is completed, and the operating system of the intelligence board completes the trusted measurement for the Boot Rom and the BMC Flash of the server.

Step S607: perform on-off switching between the SPI bus and the PCIE bus.

In this embodiment, after completing the trusted measurement on the Boot Rom and the BMC Flash of the server, the operating system of the intelligence board notifies the sequential control module of the server to complete on-off switching between the serial peripheral interface SPI bus and the peripheral component interface express (PCIE).

Step S608: power on the BMC and the central processing unit of the server.

In this embodiment, an on-off switching is made between the serial peripheral interface bus and the peripheral component interface express, and the BMC and the central processing unit of the server are powered on through the sequential control circuit of the server.

Step S609: complete the power-on of the whole machine.

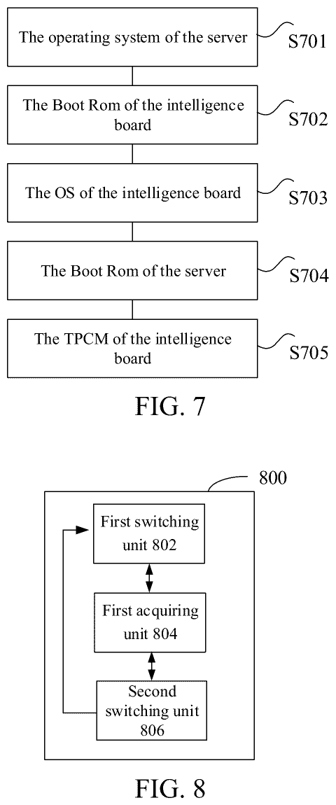

FIG. 7 is a schematic diagram of a trusted chain transfer according to an embodiment of the present disclosure. As shown in FIG. 7, the system has a trusted chain transfer process that may include the following steps.

Step S701: the operating system of the server.

In this embodiment, the operating system of the server is started.

Step S702: the Boot Rom of the intelligence board.

In this embodiment, a Boot Rom program of the intelligence board is started and the operating system (OS) of the intelligence board is measured, to ensure that the OS of the intelligence board is trusted.

Step S703: the OS of the intelligence board.

In this embodiment, a Boot Rom program of the intelligence board is started and the operating system of the intelligence board is measured, to ensure that the operating system (OS) of the intelligence board is trusted.

Step S704: the Boot Rom of the server.

In this embodiment, an operating system program of the intelligence board is started, the Boot Rom of the server is measured, to ensure that the Boot Rom of the server is trusted.

Step S705: the TPCM of the intelligence board.

In this embodiment, the TPCM of the intelligence board is started and the operating system of the server is measured, to ensure that the operating system of the server is trusted.

In the present disclosure, the trusted measurement prior to the startup of a server is accomplished by means of time division multiplexing of a PCIE physical connection for the server, and bus switching and sequential control are completed by a trusted measurement apparatus, thereby achieving the following technical effects: the trusted measurement of the server by an intelligence board can be completed as long as a peripheral component interface express slot is inserted without extra addition of a serial peripheral interface cable; a trusted platform control module of the intelligence board is a unique trusted root of the entire system, and a single trusted chain is transferred from the intelligence board to the server; for the operating system of the intelligence board, trusted platform module software is run to perform trusted measurement of the server, which is highly flexible, thermally upgraded, and migratable; the whole machine only needs one trusted platform control module to complete serial connection of a trusted chain, thereby reducing material costs as well as operation and maintenance costs; interface resources are saved for the intelligence board; and the trusted measurement is also supported in a scenario where a single intelligence board is connected to multiple servers.

To be noted, the foregoing method embodiments are described as a series of action combinations for the sake of brief description. However, those skilled in the art should understand that the present disclosure is not limited to the described sequence of actions, since some steps may be performed in another sequence or simultaneously according to the present disclosure. Secondly, those skilled in the art should also know that the embodiments described in the description are preferred embodiments, and the involved actions and modules are not necessary to the present disclosure.

Through the description of the foregoing implementations, those skilled in the art can definitely know that the resource configuration method according to the foregoing embodiments may be implemented by means of software plus a necessary universal hardware platform, or certainly by hardware. However, in many cases, the former is a preferred implementation. Based on such understanding, the technical solutions of the present disclosure in substance or a part thereof contributing to the existing technology may be reflected in the form of a software product stored in a storage medium (such as a Rom/RAM, a diskette or an optical disk), including several instructions to enable a terminal device (which may be a mobile phone, a computer, a server, a network device or the like) to execute the methods described in various embodiments of the present disclosure.

### Embodiment 4

According to an embodiment of the present disclosure, a data processing apparatus for implementing the data processing method shown in FIG. 3 is further provided.

FIG. 8 is a schematic diagram of a data processing apparatus according to an embodiment of the present disclosure. As shown in FIG. 8, the data processing apparatus 800 includes a first switching unit 802, a first acquiring unit 804 and a second switching unit 806.

The first switching unit 802 is configured to: in response to an intelligence board being powered on and trusted, switch a PCIE interface module of the intelligence board to an SPI trusted measurement interface module of the intelligence board, where the SPI trusted measurement interface module is configured to request for target data to be measured from a server through a PCIE physical connection.

The first acquiring unit 804 is configured to acquire the target data that is sent by the server through a built-in serial peripheral interface (SPI) bus and transmitted through the PCIE physical connection.

The second switching unit 806 is configured to perform trusted measurement on the target data to obtain a measurement result, where when the measurement result indicates that the server is trusted, the SPI is switched to the PCIE by the server, and the server performs data transmission through the PCIE.

To be noted here, the first switching unit 802, the first acquiring unit 804 and the second switching unit 806 correspond to steps S302 to S306 in Embodiment 2, and these three units have the same implemented instance and application scenario as those of the corresponding steps, but are not limited to the contents disclosed in Embodiment 1. It should be noted that the aforementioned units can be operated in a computer terminal A provided in Embodiment 1, as parts of the apparatus.

In the resource configuration apparatus according to the embodiment, in response to an intelligence board being powered on and trusted, a peripheral component interface express (PCIE) between the server and the intelligence board is switched to a serial peripheral interface (SPI) bus through a first switching unit, and target data to be measured by a server is acquired through the SPI, and trusted measurement is performed on the target data to obtain a measurement result; and in response to the measurement result indicating that the server is trusted, the SPI is switched to the PCIE through a second switching unit, and data transmission is performed through the PCIE. That is to say, in the present disclosure, the trusted measurement prior to the startup of the server would be accomplished by means of time division multiplexing for a first target bus of the server, without extra addition of a serial peripheral interface cable, thereby achieving the technical effect of improving the efficiency of trusted measurement on the server, and solving the technical problem of low efficiency of the trusted measurement on the server.

### Embodiment 5

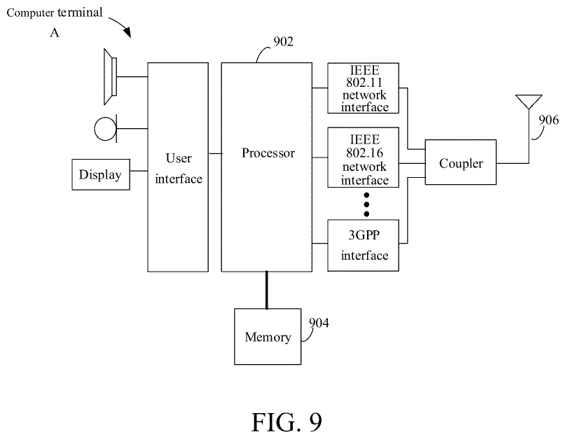

FIG. 9 is a structural block diagram of a computer terminal according to an embodiment of the present disclosure. As shown in FIG. 9, the computer terminal A may include: one or more (only one is shown in the figure) processors 902, a memory 904, and a transmission apparatus 906.

Where the memory 904 can be configured to store software programs and modules, such as program instructions/modules corresponding to the data processing method and apparatus in the embodiments of the present disclosure. The processor performs various functional applications and data processing by running the software programs and modules stored in the memory, that is, implementing the data processing method. The memory may include a high-speed random access memory or a non-volatile memory such as one or more magnetic storage apparatuses, flash memories, or other non-volatile solid-state memories. In some instances, the memory may further include memories remotely arranged to the processor, and these remote memories can be connected to a Terminal A over a network. Examples of the foregoing network include, but are not limited to, the Internet, the intranet, the local area network, the mobile communication network, and a combination thereof.

The processor 902 can invoke information and an application stored in the memory through the transmission apparatus, to perform the following steps: in response to an intelligence board being powered on and trusted, switching a PCIE interface module of the intelligence board to an SPI trusted measurement interface module of the intelligence board, where the SPI trusted measurement interface module is configured to request for target data to be measured from a server through a PCIE physical connection; acquiring the target data that is sent by the server through a built-in serial peripheral interface (SPI) bus and transmitted through the PCIE physical connection; performing trusted measurement on the target data to obtain a measurement result, where when the measurement result indicates that the server is trusted, the SPI is switched to the PCIE by the server, and the server performs data transmission through the PCIE.

An embodiment of the present disclosure provides a data processing method, the trusted measurement prior to the startup of the server would be accomplished by means of time division multiplexing for the PCIE physical connection of the server, without extra addition of the serial peripheral interface cable, thereby achieving the technical effect of improving the efficiency of trusted measurement on the server, and solving the technical problem of low efficiency of the trusted measurement on the server.

Persons of ordinarily skill in the art can understand that the structure shown in FIG. 9 is merely illustrative. The computer terminal A can also be a smart phone (such as an Android mobile phone, an iOS mobile phone, etc.), a tablet computer, a palm computer, or a terminal device such as a mobile Internet device (MID) and a PAD. FIG. 9 does not constitute a limitation to the structure of the aforementioned computer terminal A. For example, the computer terminal A may also include more or fewer components (e.g., network interfaces, display apparatuses, etc.) than those shown in FIG. 9, or have configurations different from those shown in FIG. 9.

Persons of ordinarily skill in the art may understand that all or part of the steps in the methods of the foregoing embodiments can be completed by instructing hardware related to a terminal device through a program, and the program may be stored in a computer-readable storage medium including: a flash disk, a read-only memory (ROM), a random access memory (RAM), a disk, an optical disk or the like.

### Embodiment 6

An embodiment of the present disclosure further provides a computer-readable storage medium. In the present embodiment, the computer-readable storage medium can be configured to save program codes executed by the data processing method provided in Embodiment 1.

As an example, the computer-readable storage medium is provided to store program codes for performing steps of: in response to an intelligence board being powered on and trusted, switching a PCIE interface module of the intelligence board to an SPI trusted measurement interface module of the intelligence board, where the SPI trusted measurement interface module is configured to request for target data to be measured from a server through a PCIE physical connection; acquiring the target data that is sent by the server through a built-in serial peripheral interface (SPI) bus and transmitted through the PCIE physical connection; performing trusted measurement on the target data to obtain a measurement result, where when the measurement result indicates that the server is trusted, the SPI is switched to the PCIE by the server, and the server performs data transmission through the PCIE.

Sequence numbers of the foregoing embodiments of the present disclosure are merely for description and do not represent the merits of the embodiments.

In the foregoing embodiments of the present disclosure, the description of respective embodiment has its own emphasis. For parts without detailed description in one embodiment, reference can be made to relevant descriptions of other embodiments.

In several embodiments provided in the present application, it should be understood that the disclosed technical content can be implemented in other manners. The apparatus embodiments described above are only illustrative, for example, the division of units is only a logical function division, there may be other divisions in actual implementation, for example, multiple units or components can be combined or integrated into another system, or some features can be ignored or not executed. In addition, the coupling or direct coupling or communication connection displayed or discussed can be indirect coupling or communication connection through some interfaces, units or modules, or can be in the form of electrical or other forms.

Units described as separate components may be or may not be physically separated, and components displayed as units may be or may not be physical units, that is, they can be located in one place or distributed across multiple network units. Some or all of the units can be selected according to actual needs to achieve the objective of the solution of this embodiment.

In addition, in various embodiments of the present disclosure, respective functional units can be integrated into one processing unit or exist as separate physical units, or two or more units can be integrated into one unit. The integrated unit mentioned above can be implemented in the form of hardware, and can also be implemented in the form of a software functional unit.

If the integrated unit is implemented in the form of a software functional unit and sold or used as an independent product, it can be stored in a computer-readable storage medium. Based on such understanding, the technical solution of the present disclosure in substance, or a part thereof contributing to the existing technology, or the entirety or part of the technical solution may be reflected in the form of a software product stored in a storage medium, including several instructions to enable a computer device (which may be a personal computer, a server, a network device or the like) to execute all or some of the steps in the method described in various embodiments of the present disclosure. The aforementioned storage medium includes various media capable of storing program codes, such as a USB flash disk, a read-only memory (ROM), a random access memory (RAM), a mobile disk, a magnetic disk, an optical disk or the like.

The above descriptions are only preferred embodiments of the present disclosure. It should be pointed out that, for persons of ordinarily skill in the art, improvements and modifications can be made without departing from the principles of the present disclosure, and these improvements and modifications should also be regarded as falling within the scope of protection of the present disclosure.

1. A data processing system, comprising: a server and an intelligence board, wherein the server is connected to the intelligence board through a peripheral component interface express (PCIE) physical connection, and a serial peripheral interface (SPI) bus is built in the server, wherein,
the server is configured to control power-on of the intelligence board through a sequential control circuit;
the intelligence board is configured to switch a PCIE interface module of the intelligence board to an SPI trusted measurement interface module of the intelligence board under a power-on and trustable circumstance, and the SPI trusted measurement interface module is configured to request for target data to be measured from the server through the PCIE physical connection;
wherein the intelligence board is configured to acquire the target data that is sent by the server through the SPI and transmitted through the PCIE physical connection, and perform trusted measurement on the target data to obtain a measurement result;
wherein the server is configured to switch the SPI to the PCIE when the measurement result indicates that the server is trusted, and perform data transmission through the PCIE.

2. The system according to claim 1, wherein the server comprises: an SPI on-off switching module, configured to switch the SPI to the PCIE physical connection.

3. The system according to claim 2, wherein the server comprises:
a sequential control module, configured to control the SPI on-off switching module to switch the SPI to a baseboard management controller (BMC) and a central processing unit (CPU) of the server, after the measurement result is obtained by the intelligence board through performing the trusted measurement on the target data.

4. The system according to claim 3, wherein the SPI on-off switching module is configured to control, based on the SPI, the BMC to access data in a first memory BMC Flash of the server, and control, based on the SPI, the CPU to access data in a second memory Boot Rom of the server.

5. The system according to claim 4, wherein the BMC is configured to start based on the data in the BMC Flash, the started BMC Flash is configured to control the CPU to start based on the data in the Boot Rom, and the started CPU is configured to control an operating system of the server to start, to control the PCIE for data transmission.

6. The system according to claim 4, wherein the target data comprises the data in the BMC Flash and the data in the Boot Rom.

7. The system according to claim 1, wherein the server comprises:
a PCIE on-off switching module, configured to switch the SPI to the PCIE.

8. The system according to claim 1, wherein the intelligence board comprises:
an interface switching module, configured to switch the PCIE interface module to the SPI trusted measurement interface module.

9. The system according to claim 8, wherein the interface switching module is further configured to switch the SPI trusted measurement interface module to the PCIE interface module, after the measurement result is obtained by performing the trusted measurement on the target data.

10. The system according to claim 1, wherein the intelligence board comprises:
a trusted platform control module (TPCM), configured to perform the trusted measurement on an operating system of the intelligence board, wherein a trusted operating system is configured to perform the trusted measurement on the target data to obtain the measurement result.

11. A data processing method, comprising:
in response to an intelligence board being powered on and trusted, switching a peripheral component interface express (PCIE) interface module of the intelligence board to a serial peripheral interface (SPI) bus trusted measurement interface module of the intelligence board, wherein the SPI trusted measurement interface module is configured to request for target data to be measured from a server through a PCIE physical connection;
acquiring the target data that is sent by the server through a built-in serial peripheral interface (SPI) bus and transmitted through the PCIE physical connection;
performing trusted measurement on the target data to obtain a measurement result, wherein when the measurement result indicates that the server is trusted, the SPI is switched to the PCIE by the server, and the server performs data transmission through the PCIE.

12. A non-transitory computer-readable storage medium, comprising a program stored thereon, wherein the program, when running by a processor, controls a device in which the computer-readable storage medium is located to execute the following:
in response to an intelligence board being powered on and trusted, switching a peripheral component interface express (PCIE) interface module of the intelligence board to a serial peripheral interface (SPI) bus trusted measurement interface module of the intelligence board, wherein the SPI trusted measurement interface module is configured to request for target data to be measured from a server through a PCIE physical connection;
acquiring the target data that is sent by the server through a built-in serial peripheral interface (SPI) bus and transmitted through the PCIE physical connection;
performing trusted measurement on the target data to obtain a measurement result, wherein when the measurement result indicates that the server is trusted, the SPI is switched to the PCIE by the server, and the server performs data transmission through the PCIE.

13. The system according to claim 2, wherein the intelligence board comprises:
a trusted platform control module (TPCM), configured to perform the trusted measurement on an operating system of the intelligence board, wherein a trusted operating system is configured to perform the trusted measurement on the target data to obtain the measurement result.

14. The system according to claim 3, wherein the intelligence board comprises:
a trusted platform control module (TPCM), configured to perform the trusted measurement on an operating system of the intelligence board, wherein a trusted operating system is configured to perform the trusted measurement on the target data to obtain the measurement result.

15. The system according to claim 4, wherein the intelligence board comprises:
a trusted platform control module (TPCM), configured to perform the trusted measurement on an operating system of the intelligence board, wherein a trusted operating system is configured to perform the trusted measurement on the target data to obtain the measurement result.

16. The system according to claim 5, wherein the intelligence board comprises:
a trusted platform control module (TPCM), configured to perform the trusted measurement on an operating system of the intelligence board, wherein a trusted operating system is configured to perform the trusted measurement on the target data to obtain the measurement result.

17. The method according to claim 11, wherein the method further comprises:
switching the SPI trusted measurement interface module to the PCIE interface module, after the measurement result is obtained by performing the trusted measurement on the target data.

18. The method according to claim 11, wherein the method further comprises:
performing the trusted measurement on an operating system of the intelligence board, wherein a trusted operating system is used to perform the trusted measurement on the target data to obtain the measurement result.

19. The storage medium according to claim 12, wherein the device is further controlled to execute the following:
switching the SPI trusted measurement interface module to the PCIE interface module, after the measurement result is obtained by performing the trusted measurement on the target data.

20. The storage medium according to claim 12, wherein the device is further controlled to execute the following:
performing the trusted measurement on an operating system of the intelligence board, wherein a trusted operating system is used to perform the trusted measurement on the target data to obtain the measurement result.
